(19) United States
(12) Patent Application Publication
(10) Pub. No.: US 2014/0115481 A1
(43) Pub. Date: Apr. 24, 2014

(54) METHOD FOR EXECUTING COMMUNICATION ON A MOBILE TERMINAL AND THE MOBILE TERMINAL THEREOF

(71) Applicant: Xiaomi Inc., Beijing (CN)

(72) Inventors: Wenlin Wang, Beijing (CN); Xinyu Liu, Beijing (CN); Xingping Zheng, Beijing (CN)

(73) Assignee: Xiaomi Inc., Beijing (CN)

(21) Appl. No.: 14/061,757

(22) Filed: Oct. 24, 2013

Related U.S. Application Data
(63) Continuation-in-part of application No. PCT/CN2013/078886, filed on Jul. 5, 2013.

(30) Foreign Application Priority Data
Oct. 18, 2012 (CN) 201210398162.6

(51) Int. Cl. H04L 29/06; G06F 3/0484

(52) U.S. Cl. CPC H04L 65/1069; G06F 3/0484
USPC 715/736; 709/227

(57) ABSTRACT

The embodiments of the present disclosure relate to a communication processing method for executing communication on a mobile terminal and the mobile terminal thereof, to solve a problem that the communication is accidentally interrupted by a mis-operation of a communication execution component not used by the current communication. According to the present disclosure, the method comprises receiving an operation instruction for communication, determining a sending component of the operation instruction, and switching the current communication to a second communication execution component in the case that the sending component is not the first communication execution component being used by the current communication. In the present disclosure, the corresponding operation instruction is responded only when the operation instruction is sent by the communication execution component being used by the current communication. Thus, a communication interruption caused by a mis-operation of the other communication execution components in a communication session is avoided.

### CROSS-REFERENCE TO RELATED APPLICATIONS

This application is a Continuation-In-Part of International Application PCT/CN2013/078886, with an international filing date of Jul. 5, 2013.

### TECHNICAL FIELD

The present disclosure generally relates to communication technology, and more particularly, to a communication processing method for executing communication on a mobile terminal and the mobile terminal thereof.

### BACKGROUND

With fast development of communication technology, mobile terminals have increasing functions, and the same function can be executed by various kinds of communication execution components or devices. For example, a smart mobile terminal may integrate with a Bluetooth headset, a wired headset or a receiver in the main body of the mobile terminal to perform its basic communication function, such as making voice calls or video calls.

In the case that various devices are coupled to one mobile terminal, the current or ongoing function executed on the mobile terminal may be interrupted by mis-operation via the devices. For example, in the case that a smart mobile terminal couples with a Bluetooth headset and a wired headset, the current or ongoing communication may be interrupted by an accidental press on a button of the Bluetooth headset by others if the wired headset is used for answering a call.

Therefore, in the case that the mobile terminal couples with multiple devices, the mis-operation of communication execution components not being used may interrupt the ongoing function, i.e. interrupt the communication executed on the mobile terminal.

### SUMMARY

The present disclosure provides a communication processing method for executing communication on a mobile terminal and the mobile terminal thereof, to avoid communication interruption caused by mis-operation on a communication execution component not being used.

According to one aspect of embodiments of the present disclosure, there is disclosed a communication processing method for executing communication on a mobile terminal, comprising: receiving an operation instruction for communication from a sending component coupled to the mobile terminal; determining the sending component according to the operation instruction; and switching execution of a current communication from a first communication execution component to a second communication execution component in the case that the sending component is not the first communication execution component being used by the current communication.

According to another aspect of embodiments of the present disclosure, there is disclosed a communication processing device for executing communication on a mobile terminal, comprising: a reception unit for receiving an operation instruction for communication from a sending component coupled to the mobile terminal; a determination unit for determining the sending component according to the instruction; and a processing unit for switching execution of the current communication from a first communication execution component to a second communication execution component in the case that the sending component is not the first communication execution component being used by the current communication.

According to another aspect of embodiments of the present disclosure, there is disclosed a mobile terminal for executing communication, comprising: a controller; a touch screen coupled to the controller; and a memory coupled to the controller, wherein the controller is configured to: receive an operation instruction for communication from a sending component coupled to the mobile terminal; determine the sending component according to the operation instruction; and switch execution of a current communication from a first communication execution component to a second communication execution component in the case that the sending component is not the first communication execution component being used by the current communication.

Furthermore, there is disclosed a computer readable recording medium storing one or more programs for use by a mobile terminal to perform a procedure comprising: receiving an operation instruction for communication from a sending component coupled to the mobile terminal; determining the sending component according to the operation instruction; and switching execution of a current communication from a first communication execution component to a second communication execution component in the case that the sending component is not the first communication execution component being used by the current communication.

According to the communication processing method and device provided by the embodiments of the present disclosure, during the process of communication, when an operation instruction is obtained by the mobile terminal, or specifically by a controller within the mobile terminal, the sending component sending the operation instruction may be identified and then compared with the communication execution component being used to determine whether or not to execute the current communication. If the sending component is identified to be different from the communication being used by the current communication, the current communication is then switched to be executed by another communication execution component. The operation instruction will be responded by the mobile terminal only if the sending component of the operation instruction is the communication execution component being used by the current communication. Thus, communication interruption caused by mis-operation of an idle communication execution component is avoided during the communication process.

It is to be understood that both the foregoing general description and the following detailed description of the present disclosure are exemplary and explanatory, and are intended to provide further explanation of the invention as claimed.

### BRIEF DESCRIPTION OF THE DRAWINGS

The drawings are provided to further illustrate the present disclosure, constituted part of the present specification, and used to explain the present disclosure, along with the embodiments of the present disclosure. The below drawings are provided for the purpose of illustration only, and are not limitative of the present disclosure:

FIG. 1 illustrates a mobile terminal according to an embodiment of the present disclosure;

FIG. 2 illustrates a flow chart of a communication processing method according to an embodiment of the present disclosure;

FIG. 3 illustrates a flow chart of a communication processing method according to an embodiment of the present disclosure;

FIG. 4 illustrates a schematic diagram of the configuration of a communication processing device according to an embodiment of the present disclosure.

Specific embodiments in this present disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

FIG. 1 illustrates a mobile terminal 10 according to an embodiment of the present disclosure. The mobile terminal 10 may be implemented using a variety of terminal devices. Examples of such terminal devices include mobile phones, computers, digital broadcast terminals, messaging devices, gaming consoles, tablets, pads, medical devices, exercise equipment, personal digital assistants, and the like, which is capable of executing communication thereon.

As illustrated in FIG. 1, the mobile terminal 10 has a receiver 12 and a speaker 14, which are generally required when a voice call or video call is performed on the mobile terminal 10. The mobile terminal 10 also has a touch screen 16 for displaying information to a user and receiving manual operations of the user. In certain embodiments, the mobile terminal 10 may have a screen for displaying information and a keyboard for receiving the manual operations, respectively. Furthermore, the mobile terminal 10 may further have some buttons or hotkeys 18, either in the form of software or hardware, for generating specific operation instructions in response to the manual operation of the user. For example, the hotkeys 18 may be used to hang up a call, to pick up a call, or to turn up or down the volume of a call. The specific operation instructions associated with the hotkeys may be predefined by the mobile terminal system or by the user.

In certain embodiments, a wired headset 30 may be attached to the mobile terminal 10 via a seat 20. Similar to the receiver 12 and the speaker 14, the wired headset 30 has headphones 32 and a speaker 34 for execution of the communication. Furthermore, the wired headset 30 has hotkeys 36 for generating specific operation instructions. In certain embodiments, a Bluetooth headset 40 may be coupled to the mobile terminal 10 via a Bluetooth interface (not shown) of the mobile terminal. The Bluetooth headset 40 also has headphone(s) 42, a speaker 44 and one or more hotkeys 38.

Either of the receiver 12 (mated with the speaker 14), the wired headset 30 and the Bluetooth headset 40 may be used by the mobile terminal 10 to independently execute the communication as a communication execution component. However, as the execution by the communication execution components may conflict with each other, it is generally required to activate only one of them at the same point during the communication.

The mobile terminal 10 also has a controller (not shown) to which the aforementioned components of the mobile terminal 10 are coupled. The controller can be used to receive various data information and instructions, and to process such instructions and data accordingly. The mobile terminal 10 also includes a memory (not shown) which is coupled to the controller and is used to store the instructions and data to be processed by the controller.

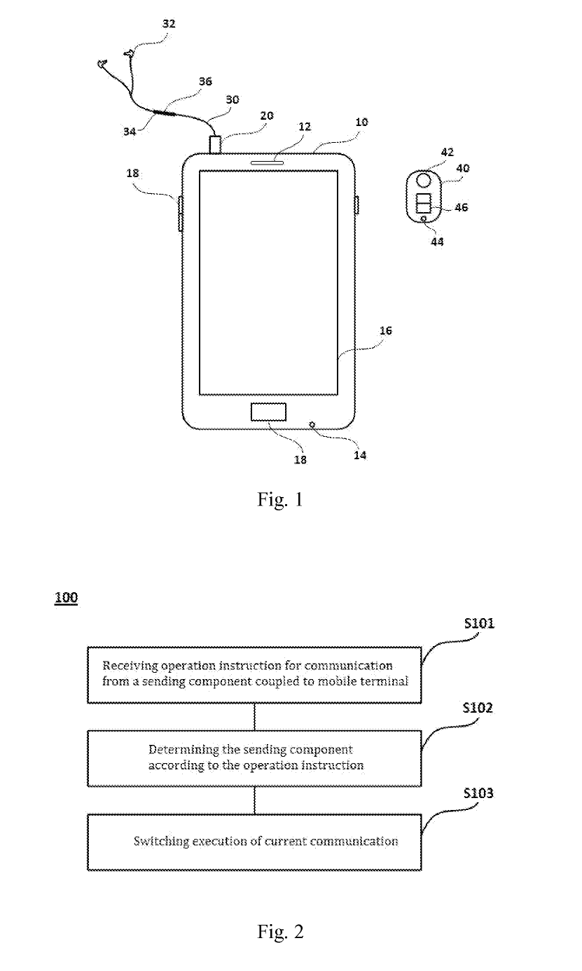

FIG. 2 illustrates a flow chart of a communication processing method 100 according to an embodiment of the present disclosure. The communication processing method may be used on the mobile terminal of FIG. 1, or other devices that is capable of executing communication thereon.

As shown in FIG. 2, the communication processing method 100 provided by the first embodiment of the present disclosure includes receiving an operation instruction for communication from a sending component coupled to the mobile terminal at step S101. The sending component is determined according to the operation instruction at step S102. That is, identifying information of the sending component, which labels the sending component and is identifiable by the mobile terminal, is obtained by the mobile terminal to determine the identity of the sending component. The identifying information may be carried in the operation instruction sent by the sending component, or otherwise associated with the operation instruction. Then at step S103, execution of a current communication is switched from a first communication execution component to a second communication execution component in the case that the sending component is not the first communication execution component being used by the current communication.

According to the communication processing method 100 of the embodiment, during the process of the current communication, the mobile terminal will not immediately respond to the received operation instruction. Instead, the current communication may be continuously executed on the mobile terminal by switching the communication execution component in the case that the sending component is not the first communication execution component. Such switching can avoid accidental interruption of the current communication, which may result from a mis-operation of the user or the like on the communication execution components.

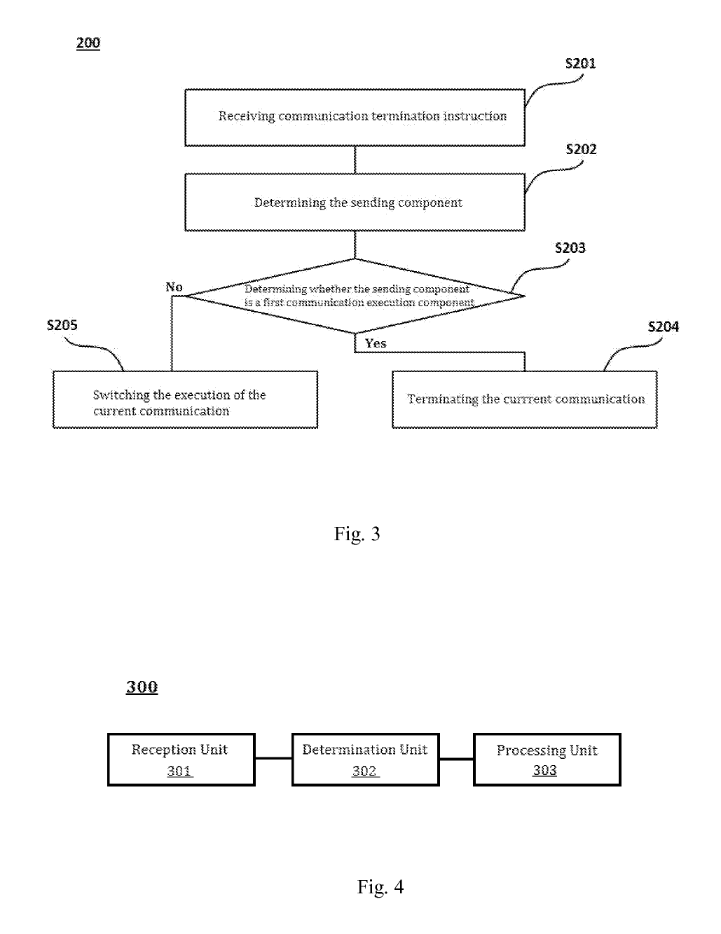

FIG. 3 illustrates a flow chart of a communication processing method 200 according to an embodiment of the present disclosure. The communication processing method 200 may be used on the mobile terminal. The communication processing method 200 according to the embodiment of the present disclosure will be elaborated with reference to practical applications or situations where the method may be used. Furthermore, the embodiment of the present disclosure is illustrated by taking the operation instruction being a communication termination instruction as an example, however, the present disclosure is not limited thereto.

As shown in FIG. 3, the communication processing method 200 in the embodiment of the present disclosure specifically includes the following steps.

In step S201, a mobile terminal receives a communication termination instruction from a sending component coupled to the mobile terminal.

Specifically, the communication termination instruction received during a current or ongoing communication can be provided by the mobile terminal itself, i.e. not by the peripheral devices of the mobile terminal such as a wired headset or Bluetooth headset. Specifically, the communication termination instruction may be generated through an input unit on the mobile terminal, such as a touch screen, a keyboard, or a button or hotkey. The term “a sending component coupled to the mobile terminal” includes devices integrated within the mobile terminal and the peripheral devices communicatively coupled to the mobile terminal. The communication termination instruction may then be sent to or obtained by a controller of the mobile terminal. The communication termination instruction can also be provided by any of the peripheral devices. For example, during a voice call or video call, the communication termination instruction for ending the call can be generated in response to the press operation on the “hang up” hotkey or button of the mobile terminal itself, or can be generated by a press operation on any hotkeys or other input units associated with the peripheral devices.

In step S202, the mobile terminal determines the sending component according to the communication termination instruction.

Specifically, upon receipt of the communication termination instruction, the information carried in the instruction needs to be analyzed to determine the sending component providing the communication termination instruction. For example, identifying information of the sending component may be obtained by the mobile terminal to determine the identity of the sending component.

In step S203, the mobile terminal determines whether the sending component of the communication termination instruction is a first communication execution component being used by the current communication or not.

Specifically, identifying information of the first communication execution component may be obtained by the mobile terminal. Then the mobile terminal may compare the identifying information of the first communication execution component with that of the sending component to determine if the communication termination instruction is provided by the first communication execution component. The mobile terminal needs to detect the first communication execution component being used by the current communication and other communication execution components capable of executing the current communication. For example, when the communication termination instruction is received, the sending component is determined whether it is the first communication execution component being used by the current communication according to the device identification information carried in the communication termination instruction. If yes, the method 200 proceeds with step S204, otherwise the method 200 proceeds with step S205.

In step S204, the mobile terminal terminates the current communication. That is to say, the mobile terminal performs the operation as indicated by the operation instruction to the communication.

In step S205, the mobile terminal switches the execution of the current communication from the first communication execution component to a second communication execution component, such that the second communication execution component proceeds with the current communication.

For example, the second communication execution component proceeding with the execution of the current communication may be the sending component sending the communication termination instruction, or any other communication execution component which may continue to execute the current communication. In this way, it is ensured that the current communication is continuously executed on the mobile terminal during the switching, and the first communication execution component would not perform the termination operation.

According to the above communication processing method 200 provided in the embodiments of the present disclosure, during the process of the current communication, when the communication termination instruction is received, the mobile terminal may identify the sending component of the communication termination instruction, and switch the execution of the current communication to other communication execution component which is capable of proceeding with the current communication in the case that the sending component of the communication termination instruction is not the communication execution component being used. The communication termination instruction may be processed by the mobile terminal to terminate the current communication only if it is provided by the communication execution component being used by the current communication, i.e. the first communication execution component. Thus, the interruption of the current communication caused by mis-operations of the other communication execution components can be avoided.

For example, after switching the execution of the current communication to the second communication execution component to continue the current communication, the method 200 further includes a step of detecting a switch instruction provided by a user through a user interface of the mobile terminal. The switch instruction indicates to switch the current communication back to the first communication execution component. When the switch instruction provided by the user through the user interface of the mobile terminal is detected, the execution of the current communication may be switched back to the first communication execution component from the second communication execution component in response to the switch instruction.

For example, the user can preset an operation instruction for performing the switch. When prompted whether or not to perform a component switch on the screen or the user interface of the mobile terminal, the user can provide a manual operation so as to generate the switch instruction directly on the user interface of the mobile terminal. The switch instruction may be compared with the preset operation instruction defined by the user to determine whether or not to perform the switch operation. If the comparison result indicates that the switch instruction provided by the user through the user interface of the mobile terminal matches the preset operation instruction for performing the switch, the mobile terminal can switch the execution of the current communication from the second communication execution component back to the first communication execution component.

According to certain embodiments of the present disclosure, the user may select whether to switch the current communication back to the former execution component through the user interface of the mobile terminal, which can delay the communication interruption. Furthermore, such user selection can switch the communication session back to the former execution component in time if the user accidentally presses the keys on the other communication execution components coupled to the mobile terminal.

The communication processing method according to embodiments of the present disclosure will be elaborated with reference to practical scenarios. In the subsequent paragraphs, the scenarios generally relate to executing a call session through a mobile terminal. However, the present disclosure is not limited thereto. It will be readily appreciated by people skilled in the art that any other audio information is captured or any other audible process or application is executed through the mobile terminal and/or its peripheral devices.

As described above, during the process of an ongoing call performed by the mobile terminal, the communication execution component executing the phone call may be a receiver of the mobile terminal, or may also be a wired headset or a Bluetooth device or other peripheral devices coupled to the mobile terminal. When any of the above communication execution components is executing the phone call, the communication via the phone call may be interrupted if any key of the other communication execution components is touched or pressed accidentally.

In this embodiment of the present disclosure, a communication session of an ongoing call performed with the communication processing method is elaborated in situations that the mobile terminal couples with various peripheral devices, but the present disclosure is not limited thereto.

Specifically, the mobile terminal first determines the communication execution component used by the current communication, and the peripheral devices coupled thereto.

For case A: the mobile terminal couples with a wired headset and a Bluetooth headset

Situation A1: where it is determined that the mobile terminal is receiving the phone call through a receiver on the mobile terminal. If the “hang up” hotkey on the mobile terminal is touched or pressed, the phone call is hung up immediately. And if the key on the wired headset or the Bluetooth headset is touched, the device for receiving the phone call in the current communication session is switched from the receiver to the wired headset or the Bluetooth device.

Situation A2: where it is determined that the mobile terminal is receiving the phone call through the wired headset. If the key on the Bluetooth device is touched, the execution of the current communication session is switched to the Bluetooth device, and only the termination instruction sent by the Bluetooth device is responded by the mobile terminal. If the key on the mobile terminal is touched, the execution of the current communication session is switched to the receiver. Because the wired headset may replace the receiver on the mobile terminal, the wired headset may continue to receive the phone call.

Situation A3: where it is determined that the mobile terminal is receiving the phone call through the Bluetooth device. If the key on the Bluetooth device is touched, then the phone call is immediately terminated. And if the key on the wired headset is touched, then the execution of the current communication session is switched to the wired headset, i.e., the device for receiving the phone call is switched from the Bluetooth device to the wired headset. Furthermore, if the key on the mobile terminal is touched, the wired headset continues to receive the phone call, as the wired headset may be used instead of the receiver of the mobile terminal.

For case B: the mobile terminal only connecting to the Bluetooth device

Situation B1: where it is determined that the mobile terminal is receiving the phone call through the Bluetooth device. If the key on the Bluetooth device is touched, the communication session is terminated immediately. If the key on the mobile terminal is touched, the execution component used by the current communication session is switched from the Bluetooth device to the receiver of the mobile terminal.

Situation B2: where it is determined that the mobile terminal is receiving the phone call through the receiver of the mobile terminal. If the “hang up” hotkey on the mobile terminal is touched, the communication session is terminated immediately. And if the key on the Bluetooth device is detected being touched to provide a communication termination instruction, the current communication session is switched from the receiver to the Bluetooth device.

Because the mobile terminal only couples with the Bluetooth device, the wired headset does not take part in the current communication.

For case C: the mobile terminal only couples with the wired headset

If the key on the wired headset is touched, the current communication session is terminated. And if the key on the mobile terminal is touched, the execution of the current communication session is switched to the receiver of the mobile terminal.

For example, as discussed above in the embodiment of the present disclosure, the wired headset may be used in place of the receiver of the mobile terminal. Therefore, when the key on the mobile terminal is touched, it is required to switch the execution of the communication session to the receiver of the mobile terminal to avoid a communication interruption, although it is possible to continue to use the wired headset for receiving the phone call.

For case D: the mobile terminal does not couple with any peripheral devices

In this case, the mobile terminal only responds to a communication termination instruction provided by the mobile terminal itself, i.e. generated by the input units integrated within the mobile terminal. If a communication termination instruction is received, the current communication session is immediately terminated without performing a switch.

For example, in the above procedure, if the communication termination instruction is not sent from the execution device being used by the current conversation, the execution of the current conversation is switched to the device from which the communication termination instruction is sent. In addition, after the execution device is switched, a prompt may be popped up on the interface or screen for the user to select whether or not to perform the execution device switch or not. If the user select yes, the communication may be switched back to the former execution device, which may delay the communication interruption. Furthermore, the communication may be switched back to the former execution device in time in the case of mis-operation.

For example, the user may set in advance whether to use the current execution device to receive the operation instruction corresponding to the current communication, such as pressing a key or sliding on the screen and so on. If the user provides a switch instruction, the mobile terminal will determine whether the switch instruction matches the preset operation instruction. If they match with each other, the current execution device will be switched back to the former execution device to continue the current communication.

For example, the above mentioned communication session may be continuously executed on the mobile terminal. That is to say, the switch between different execution devices will not terminate the communication session. Thus, the communication process may be optimized and user experience is significantly improved.

According to the communication processing method provided by the embodiments of the present disclosure, in the case that a communication termination instruction is sent by the execution device not used by the current communication, a switch of the execution device is performed rather than responding to the communication termination instruction and ending the current conversation, which may avoid a conversation interruption caused by a mis-operation when the mobile terminal connects to multiple peripheral devices. In addition, an information indicating whether to perform a switch may be popped up at an appropriate time, which allows the user to switch the current execution device, and allows the user to switch back to the former execution device in time when a mis-operation occurs.

FIG. 4 illustrates a communication processing device 300 according to an embodiment of the present disclosure. The communication processing device 300 is used for executing communication on a mobile terminal. For example, the communication processing device 300 may be integrated within the mobile terminal.

As shown in FIG. 4, the communication processing device includes: a reception unit 21 for receiving an operation instruction for communication from a sending component coupled to the mobile terminal; a determination unit 22 for determining the sending component according to the received operation instruction; and a processing unit 23 for switching execution of the current communication from a first communication execution component to a second communication execution component in the case that the sending component determined by determination unit 22 is not the first communication execution component being used by the current communication.

For example, the processing unit 23 is further configured to perform an operation indicated by the operation instruction to the current communication in the case that the sending component is the first communication execution component being used by the current communication.

For example, the processing unit is further configured to perform an operation indicated by the operation instruction to the current communication in the case that the sending component is the first communication execution component being used by the current communication.

For example, the process unit 23 is further configured to detect a switch instruction provided by a user through a user interface of the mobile terminal, which indicates to switch the execution of the current communication back to the first communication execution component after switching the execution of the current communication to the second communication execution component; and to switch the execution of the current communication from the second communication execution component back to the first communication execution component in response to the switch instruction.

Specifically, the processing unit is further configured to compare the switch instruction with a preset operation instruction for performing the switching and switch the execution of the current communication from the second communication execution component back to the first communication execution component in the case that the switch instruction provided by the user matches the preset operation instruction.

For example, the second execution component is the sending component of the operation instruction.

For example, the current communication is continuously executed on the mobile terminal when switching its execution.

According to communication processing devices of the embodiments of the present disclosure, in a communication session, when an operation instruction is received, the sending component of the operation instruction will be judged. The current communication will be switched to other communication execution components in the case that the sending component of the operation instruction is not the communication execution component being used by the current communication. The corresponding operation instruction is responded only when the operation instruction is sent by the communication execution component being used by the current communication. Thus, a communication interruption caused by a mis-operation of other communication execution components during a communication session is avoided.

Various embodiments described herein may be implemented in a computer-readable recording medium storing one or more programs for use by one or more chips, controller, microprocessors or processors of the mobile terminal. The computer can also include the mobile terminal as defined in the present disclosure.

The computer-readable recording medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the mobile terminal.

The aforementioned methods can be implemented in a computer readable media recording computer-readable codes. The computer-readable media include all kinds of recording devices in which data readable by a computer system are stored. The computer-readable media include ROM, RAM, CD-ROM, magnetic tapes, floppy discs, optical data storage devices, and the like, as well as carrier-wave type implementations (e.g., transmission via Internet).

The foregoing description, for purpose of explanation, has been described with reference to embodiments. The present disclosure may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A communication processing method for executing communication on a mobile terminal, comprising:
receiving an operation instruction for communication from a sending component coupled to the mobile terminal;
determining the sending component according to the operation instruction; and
switching execution of a current communication from a first communication execution component to a second communication execution component in the case that the sending component is not the first communication execution component being used by the current communication.

2. The communication processing method of claim 1, the method further comprising:
detecting a switch instruction provided by a user through a user interface of the mobile terminal, which indicates to switch the execution of the current communication back to the first communication execution component after switching the execution of the current communication to the second communication execution component; and
switching the execution of the current communication from the second communication execution component back to the first communication execution component in response to the switch instruction.

3. The communication processing method of claim 2, wherein the step of switching the execution of the current communication from the second communication execution component back to the first communication execution component comprises:
comparing the switch instruction with a preset operation instruction for performing the switching;
in the case that the switch instruction provided by the user matches the preset operation instruction, switching the execution of the current communication from the second communication execution component to the first communication execution component.

4. The communication processing method of claim 1, wherein the second communication execution component is the sending component providing the operation instruction.

5. The communication processing method of claim 1, wherein the current communication is continuously executed on the mobile terminal when switching its execution.

6. The communication processing method of claim 1, the method further comprising:
in the case that the sending component is the first communication execution component, performing an operation indicated by the operation instruction to the current communication.

7. A mobile terminal for executing communication, comprising:
a controller;
a touch screen coupled to the controller; and
a memory coupled to the controller,
wherein the controller is configured to:
receive an operation instruction for communication from a sending component coupled to the mobile terminal;
determine the sending component according to the operation instruction; and
switch execution of a current communication from a first communication execution component to a second communication execution component in the case that the sending component is not the first communication execution component being used by the current communication.

8. The mobile terminal of claim 7, wherein the controller is further configured to:
detect a switch instruction provided by a user through a user interface of the mobile terminal, which indicates to switch the execution of the current communication back to the first communication execution component after switching the execution of the current communication to the second communication execution component, and
switch the execution of the current communication from the second communication execution component back to the first communication execution component in response to the switch instruction.

9. The mobile terminal of claim 8, wherein the controller is further configured to:
compare the switch instruction with a preset operation instruction for performing the switching; and
switch the execution of the current communication from the second communication execution component back to the first communication execution component in the case that the switch instruction provided by the user matches the preset operation instruction.

10. The mobile terminal of claim 7, wherein the second communication execution component is the sending component providing the operation instruction.

11. The mobile terminal of claim 7, wherein the current communication is continuously executed on the mobile terminal when switching its execution.

12. The mobile terminal of claim 7, wherein the controller is further configured to perform an operation indicated by the operation instruction to the current communication in the case that the sending component is the first communication execution component being used by the current communication

13. A computer readable recording medium storing one or more programs for use by a mobile terminal to perform a procedure comprising:
receiving an operation instruction for communication from a sending component coupled to the mobile terminal;
determining the sending component according to the operation instruction; and
switching execution of a current communication from a first communication execution component to a second communication execution component in the case that the sending component is not the first communication execution component being used by the current communication.

14. The computer readable recording medium of claim 13, wherein the procedure further comprises:
detecting a switch instruction provided by a user through a user interface of the mobile terminal, which indicates to switch the execution of the current communication back to the first communication execution component after switching the execution of the current communication to the second communication execution component; and
switching the execution of the current communication from the second communication execution component back to the first communication execution component in response to the switch instruction.

15. The computer readable recording medium of claim 14, wherein the step of switching the execution of the current communication from the second communication execution component back to the first communication execution component comprises:
comparing the switch instruction with a preset operation instruction for performing the switching;
in the case that the switch instruction provided by the user matches the preset operation instruction, switching the execution of the current communication from the second communication execution component to the first communication execution component.

16. The computer readable recording medium of claim 13, wherein the second communication execution component is the sending component providing the operation instruction.

17. The computer readable recording medium of claim 13, wherein the current communication is continuously executed on the mobile terminal when switching its execution.

18. The computer readable recording medium of claim 13, wherein the procedure further comprises:
in the case that the sending component is the first communication execution component, performing an operation indicated by the operation instruction to the current communication.
